(19) United States
(12) Patent Application Publication
(10) Pub. No.: US 2015/0252595 A1
(43) Pub. Date: Sep. 10, 2015

(54) DEADBOLT-ACTIVATED SUPPLEMENTAL LOCK

(71) Applicant: Amesbury Group, Inc., Amesbury, MA (US)

(72) Inventors: Bruce Hagemeyer, Pella, IA (US); Gary E. Tagtow, Sioux Falls, SD (US); Dan Raap, Hartford, SD (US)

(73) Assignee: Amesbury Group, Inc., Amesbury, MA (US)

(21) Appl. No.: 14/633,277

(22) Filed: Feb. 27, 2015

Related U.S. Application Data
(60) Provisional application No. 61/947,602, filed on Mar. 4, 2014.

(51) Int. Cl. E05C 1/02

(52) U.S. Cl. CPC E05C 1/02

(57) ABSTRACT

A lock system has an elongate channel, a drive bar disposed within the housing, a locking element adapted to be actuated by the drive bar from a retracted position to an extended position; and a linkage connected to the drive bar. The linkage is adapted to be actuated from a first position to a second position by selective contact with a deadbolt disposed external to the elongate channel. Moving the linkage from the first position to the second position actuates the locking element from the retracted position to the extended position.

### CROSS-REFERENCE TO RELATED APPLICATIONS

This application claims priority to and the benefit of U.S. Provisional Patent Application Ser. No. 61/947,602, filed Mar. 4, 2014, entitled, “Deadbolt-activated Supplemental Lock,” the disclosure of which is hereby incorporated by reference herein in its entirety.

### INTRODUCTION

Locks are installed on hinged and sliding doors to lock the door within the frame for security purposes. Hinged doors, for example, typically include a locking latch. The latch holds the door closed but does not necessarily lock the door. The latch may be actuated by turning an associated door knob or by pressing a thumb actuator to release the latch. In certain doors, the latch may be locked to provide a degree of security. Doors (such as exterior doors) that include latches often include a deadbolt to provide enhanced security. The deadbolt extends into the door frame to hold the door in place. The deadbolt is actuated by a thumb turn on the interior of the door or by a lock cylinder on the exterior of the door. When the deadbolt is extended into the frame, a robust locking result is achieved. Doors that utilize deadbolts may still be defeated, however, since it is generally well known by an intruder that the deadbolt is disposed proximate the center of the door, near the lock cylinder. Thus, intruders often concentrate their breaching efforts against the center of the door to defeat the lock.

### SUMMARY

The locking systems disclosed herein fit in a hinged or sliding door frame, where the door utilizes an off-the-shelf latch and a deadbolt at a standard or other bore spacing. When the door is closed and the deadbolt is thrown, the end of the deadbolt extends into a lock housing disposed on the door frame. Within the housing are one or two linkages that, when actuated by the deadbolt, extend one or more locking elements from the lock housing. These locking elements may be disposed above and/or below the deadbolt. The end of the deadbolt pushes on an element in the locking system linkages that operate drive bars that extend locking elements. The deadbolt is still functional. Thus, depending on the number of locking elements used, multiple lock points between the frame and door panel result. The linkage operates the locking elements. In certain embodiments, locking elements may be located both above and below the deadbolt. The bolt housings and linkages may be extended to put the bolts higher and lower on the door if desired.

In one aspect, the technology relates to a lock system having: an elongate channel; a drive bar disposed within the housing; a locking element adapted to be actuated by the drive bar from a retracted position to an extended position; and a linkage connected to the drive bar, wherein the linkage is adapted to be actuated from a first position to a second position by selective contact with a deadbolt disposed external to the elongate channel, and wherein moving the linkage from the first position to the second position actuates the locking element from the retracted position to the extended position. In an embodiment, a housing defines an opening aligned with the linkage, wherein the opening is adapted to receive the deadbolt. In another embodiment, the linkage includes a pivotable actuator. In yet another embodiment, the pivotable actuator is pivotably connected to the housing at a pivot point, and wherein the pivotable actuator includes: a contact leg, wherein the contact leg is adapted to contact the deadbolt; and a link leg, wherein the link leg is connected to the drive bar, wherein the contact leg and link leg are connected to each other proximate the pivot point. In still another embodiment, the locking element is pivotably connected to the drive bar.

In another embodiment of the above aspect, the drive bar is adapted for a vertical movement within the elongate channel between a first vertical position and a second vertical position. In an embodiment, the linkage and the drive bar translate horizontal movement of the deadbolt into rotational movement of the locking element. In another embodiment, the drive bar includes a first drive bar and a second drive bar; wherein the locking element includes a first locking element actuated by the first drive bar and a second locking element actuated by the second drive bar; and wherein the linkage includes a first linkage connected to the first drive bar and a second linkage connected to the second drive bar. In yet another embodiment, the first locking element is disposed on a first side of the deadbolt and the second locking element is disposed on a second side of the deadbolt when the lock system is installed in a door frame.

In another aspect, the technology relates to a lock system having: a housing configured to be installed in at least one of a door frame and a locking edge of a door, wherein the housing defines an opening for receiving a deadbolt extending from a door panel; a first pivotable actuator disposed proximate the opening, wherein the first pivotable actuator is configured to contact the deadbolt; a first linkage connected to the first pivotable actuator; a first drive bar connected to the first linkage; and a first pivotable locking element connected to the first drive bar, wherein a force applied by the deadbolt to the first pivotable actuator pivots the first pivotable actuator, wherein the pivoting of the first pivotable actuator moves substantially linearly and pivotably the first linkage, wherein the substantially linear and pivotal movement of the first linkage moves the first drive bar linearly, and wherein the linear movement of the first drive bar pivots the first pivotable locking element to an extended position. In an embodiment, a first U-shaped channel defines an opening, wherein the first drive bar and at least a portion of the first linkage are disposed in the first U-shaped channel, and wherein when the first pivotable locking element is in the extended position, the first pivotable locking element extends through the opening. In another embodiment, the first U-shaped channel is connected to the housing. In yet another embodiment, both of the first pivotable actuator and the first pivotable locking element pivot in a first direction upon application of the force from the deadbolt to the first pivotable actuator. In still another embodiment, the housing defines a longitudinal axis and wherein the first direction is about an axis substantially orthogonal to the longitudinal axis.

In another embodiment of the above aspect, the lock system further includes a U-shaped channel, wherein the first pivotable locking element is pivotably connected to the U-shaped channel and wherein the first drive bar is slidably connected to the U-shaped channel. In an embodiment, the U-shaped channel is connected to the housing. In another embodiment, a second pivotable actuator disposed proximate the opening, wherein the second pivotable actuator is configured to contact the deadbolt; a second linkage connected to the second pivotable actuator; a second drive bar connected to the second linkage; and a second pivotable locking element connected to the second drive bar, wherein a force applied by the deadbolt to the second pivotable actuator pivots the second pivotable actuator, wherein the pivoting of the second pivotable actuator moves substantially linearly and pivotably the second linkage, wherein the substantially linear and pivotal movement of the second linkage moves the second drive bar linearly, and wherein the linear movement of the second drive bar pivots the second pivotable locking element to an extended position. In yet another embodiment, both of the second pivotable actuator and the second pivotable locking element pivot in a second direction upon application of the force from the deadbolt to the second pivotable actuator.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 depicts a perspective view of a deadbolt-activated supplemental lock.

FIGS. 2A and 2B depict front and rear exploded perspective views, respectively, of the deadbolt-activated supplemental lock of FIG. 1.

FIGS. 3A and 3B depict side sectional views of a door frame and a deadbolt-activated supplemental lock, in unlocked and locked conditions, respectively.

FIG. 4 is a schematic perspective view of a locking member.

FIG. 5 is a partial side sectional view of a deadbolt-activated supplemental lock.

### DETAILED DESCRIPTION

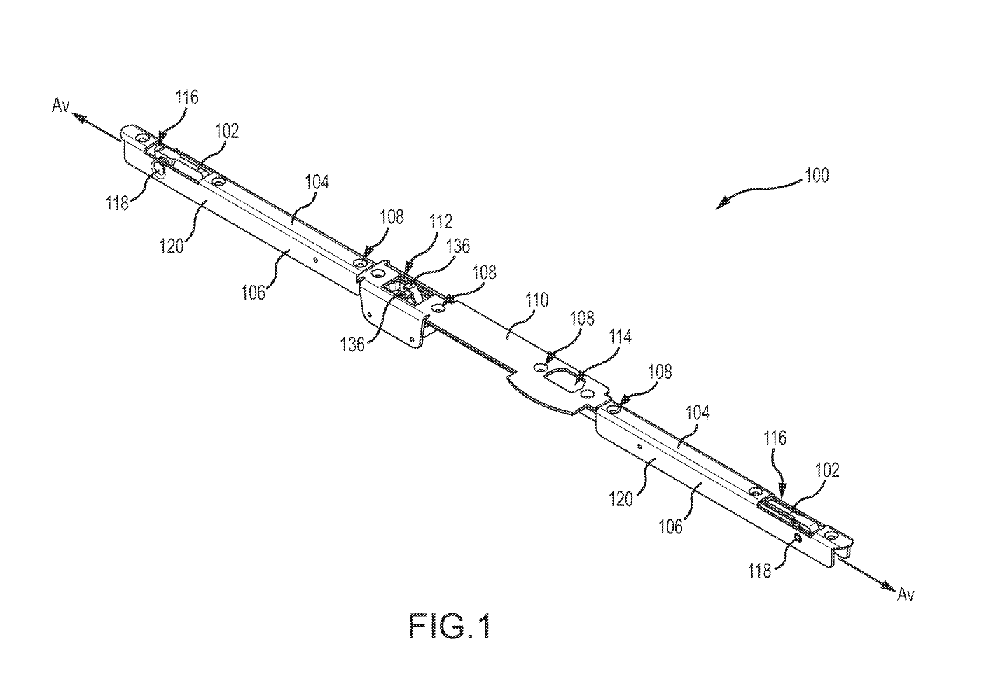

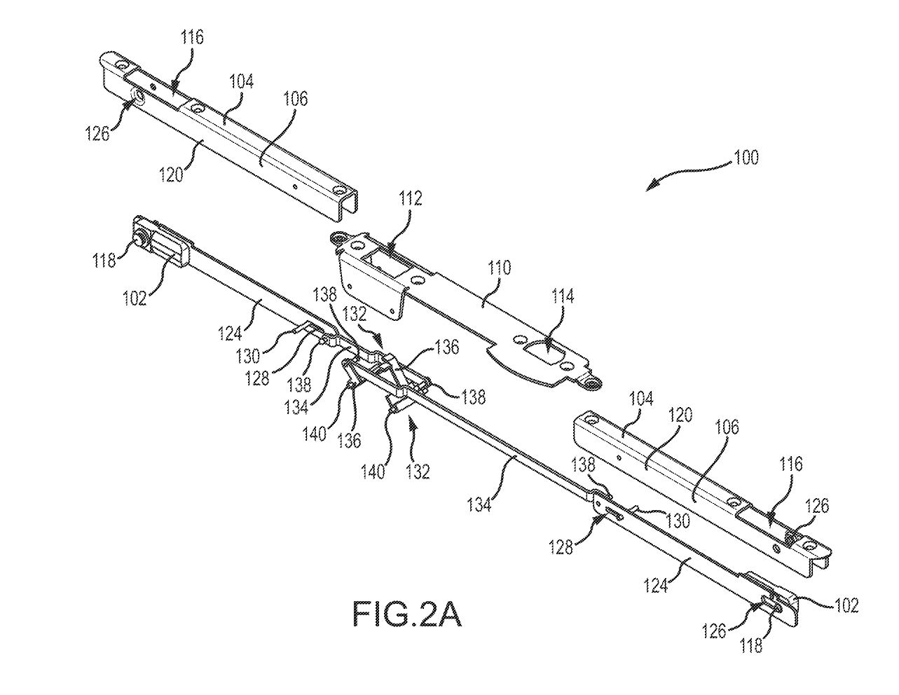

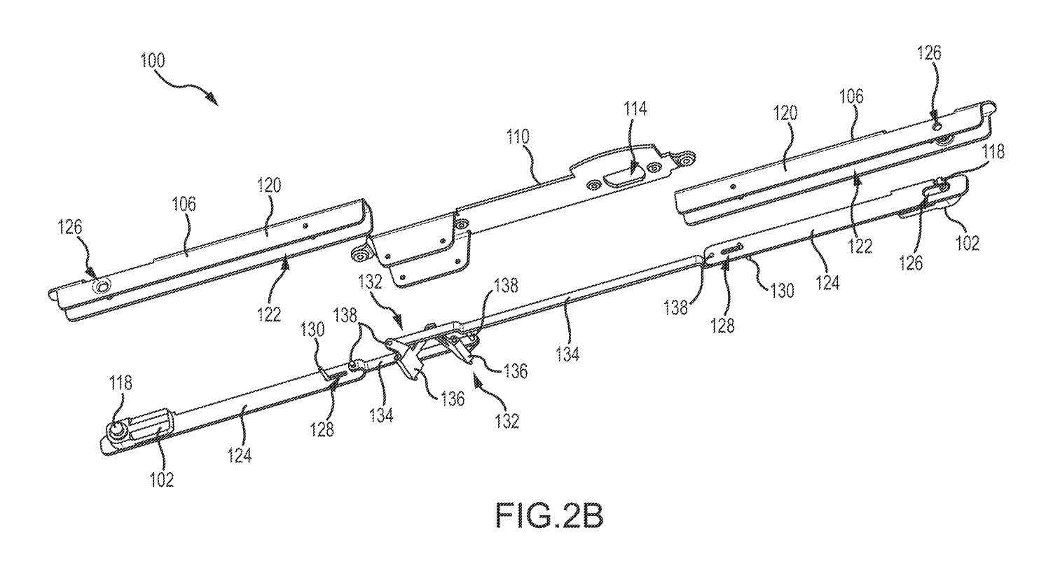

FIG. 1 depicts a perspective view of a deadbolt-activated supplemental lock 100. The multi-point lock 100 includes two spaced locking members 102. A base 104 of an elongate U-shaped channel 106 (described in more detail below in FIG. 2) is recessed into a door frame or a locking edge of an opposing door. For clarity, the lock 100 will be described as being installed in a door frame. A cover plate or face plate (not shown) may be secured to the base 104 through one or more screw holes 108 to cover the supplemental lock 100 for aesthetic purposes. The screw holes 108 can additionally be used with screws or other fasteners to secure the channel 106 to a door frame. The cover plate may also cover a centrally-disposed housing 110 that is connected to each of the two U-shaped channels 106. In another embodiment, the housing 110 and the U-shaped channels 106 define a unitary part. The screw holes 108 can additionally be used with screws to secure the channels 106 and housing 110 to the door frame. The housing 110 may define a deadbolt opening 112 configured to receive a deadbolt that extends from a pivoting or sliding door disposed opposite the door frame, as well as a latch opening 114 configured to receive a latch similarly located.

As described above, the supplemental lock 100 may include two locking members 102, but in certain embodiments, as few as one or more than two locking members may be utilized. When in the retracted position, as depicted in FIG. 1, the locking members 102 are retracted within the U-shaped channel 106. The base 104 of the channel 106 defines two apertures 116, through which the locking members 102 extend when in the locked or extended position. Pivot pins 118 pivotally secure the locking members 102 to the sides 120 of the U-shaped channel 106.

FIGS. 2A and 2B depict front and rear exploded perspective views, respectively, of the deadbolt-activated supplemental lock 100 of FIG. 1, and are described simultaneously. A number of components of the lock 100 are described above in FIG. 1 and are therefore not necessarily described further. Additionally, certain components and structural relationships therebetween are depicted in FIG. 1, for clarity. The sides 120 of the U-shaped channels 106 each define an elongate void 122 therebetween. The lock system 100 has a substantially vertical axis A_{V}, when installed vertically within a door frame. Disposed in each void 122 are the locking member 102 and a drive bar 124. The drive bar 124 moves in a substantially vertical direction, linearly along axis A_{V} within the U-shaped channel 106 during use, as described in more detail below. The pivot pins 118 are inserted through openings 126 defined in one or both sides 120 of the U-shaped channel 106. Elongate slots 126 in the drive bar 124 provide clearance for the pivot pins 118 during linear movement of the drive bar 124. The drive bar 124 may define additional elongate slots 128 that provide clearance for stationary guide pins 130 that are secured to the U-shaped channel 106 so as to guide movement of the drive bar 124.

The drive bar 124 is connected to a linkage 132. The linkage 132 includes link leg 134 that is, in turn, connected to a contact leg or pivoting actuator 136. Each pivoting actuator 136 projects into the deadbolt opening 112 and is configured to contact a deadbolt extending from the associated door. Upon a contact force being applied by a deadbolt to the pivoting actuator 136, the pivoting actuator 136 pivots. This pivoting movement causes a corresponding pivoting and linear movement of the link leg 134, which in turn linearly moves the drive bar 124. This linear movement of the drive bar 124 is translated into pivotal movement of the locking element 102, as described in further detail below. In the depicted embodiment, various elements (e.g., pivoting actuator 136, link leg 134, drive bar 124) are connected with pivoting connection pins 138. The pivoting actuators 136 are configured to pivot about pivot pins 140 secured to the housing 110.

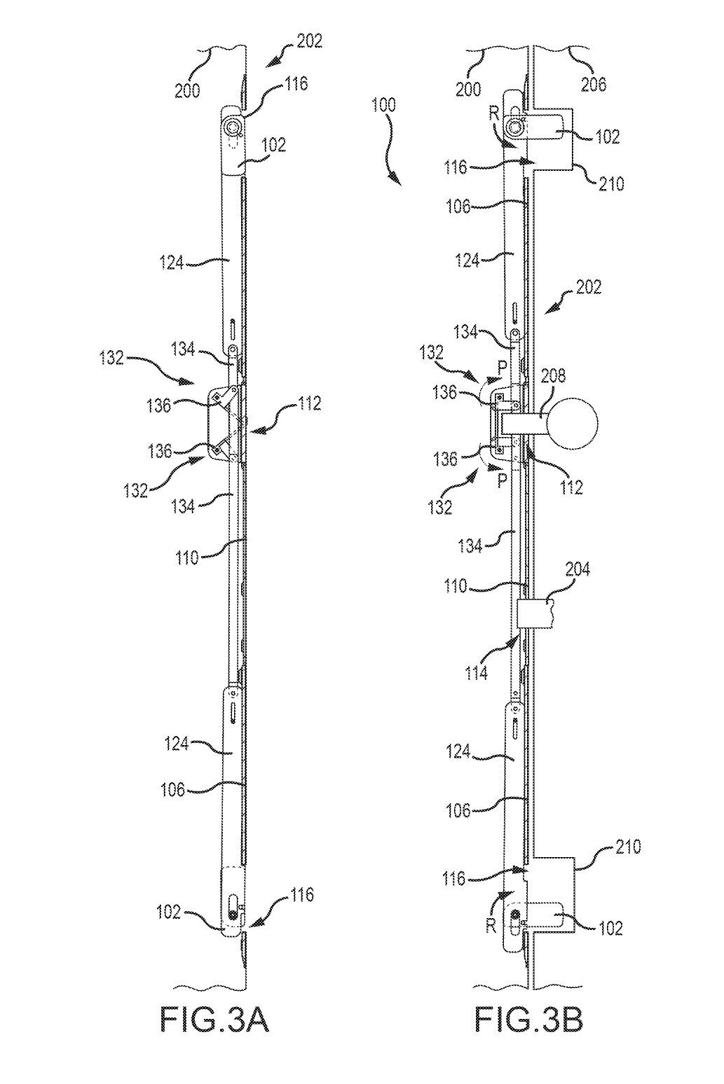

FIGS. 3A and 3B depict side sectional views of a door frame 200 and a deadbolt-activated supplemental lock 100, in unlocked and locked conditions, respectively, and are described simultaneously. A number of components of the lock 100 are described above in FIGS. 1, 2A, and 2B and are therefore not necessarily described further. Additionally, certain components and structural relationships therebetween are depicted in the previous figures, for clarity. FIGS. 3A-3B depict an edge view of the door frame 200, depicting a deadbolt-activated supplemental lock system 100. The lock system 100 is installed in a slot formed in the locking edge 202 of the door frame 200, behind a strike plate or housing 110 that defines a latch opening 114 to receive the latch 204 from the associated latch mechanism in the door 206. Additionally, the housing 110 defines a deadbolt opening 112 to receive the deadbolt 208 from the door 206. The housing 110 may be connected to or discrete from one or more U-shaped channels 106, only the base 104 of which are shown for clarity. In the depicted embodiment, the U-shaped channels 106 are depicted, one above and one below the housing 110. Each U-shaped channel 106 defines an opening 116 through which a locking element 102 may extend when moved to a locked position (as depicted in FIG. 3B).

In the unlocked condition of FIG. 3A, each of the pivoting actuators 136 are disposed in a first position proximate the deadbolt opening 112. The locking elements 102 are retracted within the U-shaped channel 106. Each locking element 102 is connected to the drive bar 124 with a drive pin 142. Each drive pin 142 engages a drive pin opening in the locking member 102, as well as a drive pin recess in the drive bar 124. Then the deadbolt 208 enters the deadbolt opening 112, it contacts and pivots P the pivotable actuators 136 of the linkages 132. This pivots P the pivotable actuators 136 to a second position which, in turn, pivots and moves linearly the link leg 134. This moves the drive bar 124 vertically along axis A_{V} relative to the U-shaped channel 106. This causes the locking members 102 to rotate R around pivot pins 118. When the drive bar 124 is driven, the rotation R extends the locking members 102 from a first, retracted position (depicted in FIG. 3A) to a second, extended position (depicted in FIG. 3B). As can be seen, as one of the pivotable actuators 136 pivots P, the associated locking member 102 rotates in the same direction. These pivoting or rotational movements of the pivotable actuator 136 and the locking element 102 are about axes substantially orthogonal to the axis A_{V}. In the retracted position, the locking members 102 are contained within the U-shaped channel 106 and the door can be opened and closed. In the extended position, the locking members 102 extend through the aperture 116 of the U-shaped channel 106, engaging keepers 210 on a locking edge of the door, locking the door in a closed position. In the depicted embodiments, the locking members 102 are of a linear configuration, but hooked locking members may also be utilized. Such a configuration enables the lock system 110 to be utilized in applications such as sliding doors.

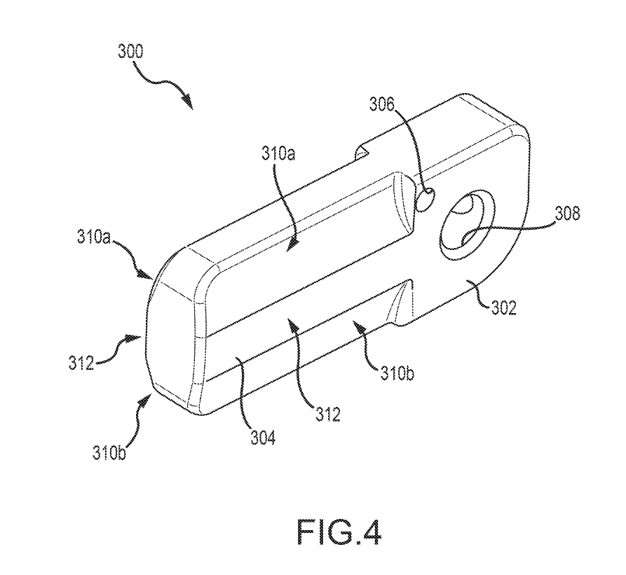

FIG. 4 is a schematic perspective view of a locking member 300 for a deadbolt-activated supplemental lock. The locking member 300 includes a base section 302 and a bolt section 304. The base section 302 defines a drive pin opening 306 for receipt of a drive pin, as described above, and a pivot pin opening 308 for receipt of a pivot pin. The bolt section 304 includes tapered surfaces 310 to improve performance of the lock, especially when the lock is installed so as to engage a warped panel door, or in a door frame that settles or shifts over time. The tapered leading surfaces 310a provide a lead-in to the strike located on the door. The tapered trailing surfaces 310b reduce potential surface contact between the bolt section 304 and the strike, this reducing operational forces on the supplemental lock. Substantially flat, parallel side surfaces 312 allow for secure contact between the bolt section 304 and the associated keeper.

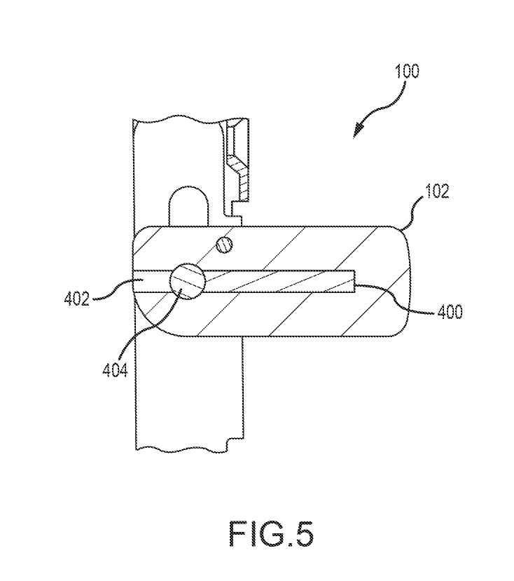

FIG. 5 is a partial side sectional view of a deadbolt-activated supplemental lock 100. For example, an upper one of the locking members 102 is depicted. The locking member 102 defines a hollow central bore, into which a hardened steel or other metal pin 400 is inserted. During assembly of the lock 100 the hardened pin 400 is inserted via an access channel 402, after which the locking member 102 is secured via a rivet 404 to a U-shaped channel. Both the hardened pin 400 and rivet 404 are a slight clearance fit within the locking member 102. The clearance fit between the hardened pin 400 and the locking member 102 prevents the locking member 102 from being cut through in an effort to defeat the lock 100. To the extent a person could access and begin to saw through the locking member 102, the hardened pin 400 has sufficient clearance within the locking member 102 to rotate circumferentially when contacted by the saw blade, thus preventing cutting of the pin 400 and complete cutting through of the locking member 102.

In addition to the embodiments of the lock depicted herein, wherein a single locking element is disposed in each of the upper U-shaped channel and the lower U-shaped channel, other embodiments are contemplated. For example, a lock system may include a single U-shaped channel, either above or below the deadbolt opening. Greater than one locking element may be utilized for each U-shaped channel. For a particular multi-point lock, the locking member, drive bar, and drive pin may be configured to allow the locking members to rotate clockwise or counter-clockwise to reach an extended position. Additionally, the same multi-point lock may utilize locking members that rotate in opposite directions as they extend during use. The locking members may be a substantially uniform shape or any shape desired. It is contemplated that the various components and configurations depicted with regard to the multi-point locks disclosed herein, as well as modifications thereof envisioned by a person of ordinary skill in the art, are interchangeable.

The various elements of the locks depicted herein may be manufactured of any materials typically used in door hardware/lock manufacture. Such materials include, but are not limited to, cast or machined steel, stainless steel, brass, titanium, etc. Material selection may be based, in part, on the environment in which the lock is expected to operate, material compatibility, manufacturing costs, product costs, etc. Additionally, some elements of the lock may be manufactured from high-impact strength plastics. Such materials may be acceptable for applications where robust security is less critical, or when a secondary, stronger material is utilized in conjunction with the plastic part (for example, a plastic locking member used in conjunction with a hardened pin manufactured of metal).

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A lock system comprising:
an elongate channel;
a drive bar disposed within the housing;
a locking element adapted to be actuated by the drive bar from a retracted position to an extended position; and
a linkage connected to the drive bar, wherein the linkage is adapted to be actuated from a first position to a second position by selective contact with a deadbolt disposed external to the elongate channel, and wherein moving the linkage from the first position to the second position actuates the locking element from the refracted position to the extended position.

2. The lock system of claim 1, further comprising a housing defining an opening aligned with the linkage, wherein the opening is adapted to receive the deadbolt.

3. The lock system of claim 1, wherein the linkage comprises a pivotable actuator.

4. The lock system of claim 3, wherein the pivotable actuator is pivotably connected to the housing at a pivot point, and wherein the pivotable actuator comprises:
a contact leg, wherein the contact leg is adapted to contact the deadbolt; and
a link leg, wherein the link leg is connected to the drive bar, wherein the contact leg and link leg are connected to each other proximate the pivot point.

5. The lock system of claim 1, wherein the locking element is pivotably connected to the drive bar.

6. The lock system of claim 1, wherein the drive bar is adapted for a vertical movement within the elongate channel between a first vertical position and a second vertical position.

7. The lock system of claim 1, wherein the linkage and the drive bar translate horizontal movement of the deadbolt into rotational movement of the locking element.

8. The lock system of claim 1,
wherein drive bar comprises a first drive bar and a second drive bar;
wherein the locking element comprises a first locking element actuated by the first drive bar and a second locking element actuated by the second drive bar; and
wherein the linkage comprises a first linkage connected to the first drive bar and a second linkage connected to the second drive bar.

9. The lock system of claim 8, wherein the first locking element is disposed on a first side of the deadbolt and the second locking element is disposed on a second side of the deadbolt when the lock system is installed in a door frame.

10. A lock system comprising:
a housing configured to be installed in at least one of a door frame and a locking edge of a door, wherein the housing defines an opening for receiving a deadbolt extending from a door panel;
a first pivotable actuator disposed proximate the opening, wherein the first pivotable actuator is configured to contact the deadbolt;
a first linkage connected to the first pivotable actuator;
a first drive bar connected to the first linkage; and
a first pivotable locking element connected to the first drive bar, wherein a force applied by the deadbolt to the first pivotable actuator pivots the first pivotable actuator, wherein the pivoting of the first pivotable actuator moves substantially linearly and pivotably the first linkage, wherein the substantially linear and pivotal movement of the first linkage moves the first drive bar linearly, and wherein the linear movement of the first drive bar pivots the first pivotable locking element to an extended position.

11. The lock system of claim 10, further comprising a first U-shaped channel defining an opening, wherein the first drive bar and at least a portion of the first linkage are disposed in the first U-shaped channel, and wherein when the first pivotable locking element is in the extended position, the first pivotable locking element extends through the opening.

12. The lock system of claim 11, wherein the first U-shaped channel is connected to the housing.

13. The lock system of claim 10, wherein both of the first pivotable actuator and the first pivotable locking element pivot in a first direction upon application of the force from the deadbolt to the first pivotable actuator.

14. The lock system of claim 13, wherein the housing defines a longitudinal axis and wherein the first direction is about an axis substantially orthogonal to the longitudinal axis.

15. The lock system of claim 10, further comprising a U-shaped channel, wherein the first pivotable locking element is pivotably connected to the U-shaped channel and wherein the first drive bar is slidably connected to the U-shaped channel.

16. The lock system of claim 15, wherein the U-shaped channel is connected to the housing.

17. The lock system of claim 10, further comprising:
a second pivotable actuator disposed proximate the opening, wherein the second pivotable actuator is configured to contact the deadbolt;
a second linkage connected to the second pivotable actuator;
a second drive bar connected to the second linkage; and
a second pivotable locking element connected to the second drive bar, wherein a force applied by the deadbolt to the second pivotable actuator pivots the second pivotable actuator, wherein the pivoting of the second pivotable actuator moves substantially linearly and pivotably the second linkage, wherein the substantially linear and pivotal movement of the second linkage moves the second drive bar linearly, and wherein the linear movement of the second drive bar pivots the second pivotable locking element to an extended position.

18. The lock system of claim 17, wherein both of the second pivotable actuator and the second pivotable locking element pivot in a second direction upon application of the force from the deadbolt to the second pivotable actuator.

19. The lock system of claim 18, wherein the second direction is opposite a direction of pivoting of the first locking element.

20. The lock system of claim 17 further comprising a U-shaped channel, wherein the second pivotable locking element is pivotably connected to the U-shaped channel and wherein the second drive bar is slidably connected to the U-shaped channel.
